(19) United States
(12) Patent Application Publication
(10) Pub. No.: US 2018/0336202 A1
(43) Pub. Date: Nov. 22, 2018

(54) SYSTEM AND METHOD TO REPRESENT DOCUMENTS FOR SEARCH IN A GRAPH

(71) Applicant: Kazem Jahanbakhsh, Vancouver (CA)

(72) Inventor: Kazem Jahanbakhsh, Vancouver (CA)

(73) Assignee: 0934781 B.C. Ltd, Vancouver (CA)

(21) Appl. No.: 15/984,237

(22) Filed: May 18, 2018

Related U.S. Application Data
(60) Provisional application No. 62/508,311, filed on May 18, 2017.

(51) Int. Cl. G06F 17/30

(52) U.S. Cl. CPC G06F 17/3053; G06F 17/30958; G06F 17/30867; G06F 17/30554; G06F 17/30011

(57) ABSTRACT

Provided is a method, datastore and computer system for determining the relevance of certain documents to providing certain services. An organization can be searched by its connection to online publications in the datastore. The datastore may be structured as a graph or a blockchain. The documents may be processed to identify their topics and demographics of the audience that view them. The topics, audience and results of publications may be compared to features in a search to provide search results.

### FIELD

The present invention is relevant to the computer fields of Internet searching, remote processing, and networks of data objects. The invention is particularly useful in determining relevance of connected data objects in a graph database representing organizations.

### BACKGROUND

Unless otherwise indicated herein, the materials described in this section are not prior art to the claims in this application and are not admitted to be prior art by inclusion in this section.

Search engines provide algorithms and data structures for identifying stored information, particularly to determine a quality of a data object with respect to a query. The information may be part of a larger data object representing some real-world objects, such as a document, image, person or company. The data objects are typically stored on large data servers accessible by the search engine on behalf of a remote client-computer, operated by a user. Existing search engine typically use keywords or defined attributes in the query to identify the best matching data as search results to return. Large search results are additionally ranked, whereby ranking typically depends on the closeness of keywords or attributes, repeated use of the matching keywords/attributes, recency of the data, or trends in access to the data.

Search engine algorithms struggle to incorporate other data objects into ranking, either because their relationships to the results are unknown or the relevance is non-determinable. Particular relationships and relevance may be knowable by a person, but no person will know all relationships and relevance.

### SUMMARY

The inventors have appreciated a need for a computer system that stores connections between first objects to be searched and second objects that provide data for calculating relevance of the first object. The second objects are characterized in the database to make such relevance calculable. Certain aspects of the invention address these needs.

According to a first aspect there is provided a computer-implemented method for searching a database that represents a graph of first data objects connected to document objects. The method comprises receiving a search query from a user; identifying a plurality of first data objects that satisfy a first part of the search query; executing a forward query in the datastore, from each of the identified first objects to identify document objects connected to one of the identified first objects; identifying topics of each document object; calculating a relevancy score for each identified document object with respect to a second part of the search query using the identified topics; ranking the first objects using the relevancy scores of document objects connected thereto; and displaying a subset of the ranked first objects to the user.

According to a second aspect there is provided a system comprising: a datastore of objects representing organizations and documents; and a query serving system. The query serving system includes: at least one processor, and memory. The memory stores: an index of the graph-based datastore, the index including lists of organization identifiers, each organization identifier associated with at least one document identifier, the at least one document identifier identifying a document object; a matrix storing a plurality of sets of topic features, one set for each document in the datastore, and instructions. The instructions, when executed by the at least one processor, cause the query serving system to: receive a query that comprises at least two parts, a first query part for identifying first data objects and a second query part for calculating relevance of document object; identify a first set of first organization identifiers that satisfy the first query part; execute a forward query path on the index from each first organization identifier to generate a set of document identifiers connected thereto,
for each document identifier, retrieve the corresponding set of topic features from the matrix, calculate a relevance score based on the retrieved set of topics features compared to the second query part;
rank the first organizations based on the relevance scores of documents connected thereto; and return search results using the ranked first organization.

According to a third aspect there is provided a search index system for a data graph, the data graph having objects connected by edges. The search index comprises: a posting list comprising organization objects and lists of document objects associated therewith; a topic matrix comprising sets of topic features for each document; an audience matrix comprising sets of demographic values for each document. The search index system is stored on a non-transitional storage medium within one or more search servers.

According to a fourth aspect there is provided a method of creating a search query. The method comprises: receiving a set of search features as a first query part from a user; displaying third data objects to the user; receiving a user-selection of third data objects; identifying, from a matrix, one set of topics for each user-selected third data object; combining the set of topics to create a second query part; and generating search results of first data objects that satisfy the first query part and that are connected in the database to second data objects that satisfy the second query part.

According to a fifth aspect there is provided a method of generating features for documents. The method comprises: scraping online media sources for a document; identify demographic data of online users that have interacted online with the document; and combining and normalizing the demographic data to create an audience vector for the document, the vector comprising a plurality of demographic values, for a plurality of demographic types.

Normalizing may comprise computing a probability mass distribution over each demographic type in the audience vector.

Further aspects of preferred embodiments of the invention are set out in the dependent claims.

### BRIEF DESCRIPTION OF THE DRAWINGS

FIG. 1 is an illustration of connections between software modules of servers and client devices.

FIG. 2 is an illustration of a user interface for search and search results.

FIG. 3 is an illustration of a business graph.

FIG. 4A is an illustration of a social media user interface for sourcing data about documents.

FIG. 4B is a set of vector representations of the document shared in FIG. 4A

FIG. 5 is a flowchart for sourcing documents to be stored by vector representations.

FIG. 6 is a flowchart for ranking objects based on user selection of related objects.

FIG. 7 is a flowchart for converting a search query into search vectors.

FIG. 8 is a flowchart for performing a search using search vectors and document vectors.

FIG. 9 is a set of representations for indices.

FIG. 10 is a table of default Return vectors per search type.

FIG. 11 is a diagram of data sharing between servers and client devices.

### DESCRIPTION

A computer system and method are described to enable a search of data objects and rank them by their connection to certain other data objects that are relevant to the search query. The system and method employ a database and algorithms particularly suited to capture and search relationship between data objects.

The object is to enable the user to search for first objects having connections to second objects along paths that includes at least one document. The number of connections and qualities of these intermediate documents are used to rank the first entities. Because the number of nodes n is on the order of many millions and potential paths to traverse is on the order of 2̂n, the system contemplates various data structures and pre-processing steps corresponding to the most common search requirements. The search engine creates a topic query and audience query, directly or indirectly from the search query. The system assigns to each document a set of topic features and a set of audience features, which are used by the search engine to score the most relevant documents and then rank the first data objects connected thereto.

In one application of the system, the entities represent organizations providing services or receiving services, such as marketing or public relations. While such organizations can readily be organized and found by a search engine using their attributes alone (i.e. firmographic data), the present system provides a way to evaluate sought organizations (aka first data objects, which are the target of the search) by identifying connections in a database to second data objects, such as media outlets, clients, documents. The present system determines whether the second data objects are relevant to the search query with regard to services provided, audience of the documents/media outlets, firmographics of the clients, and topics of the documents.

In cases where data about a Service Provider is self-provided there is also the potential for that Provider to ‘game’ the search engine by asserting false relationships and attributes. For example, someone may assert that they provide certain service and have performed same in the past to great effect. The inventors have appreciated a need for a computer system to search for and rank data objects based on the relevance of related, verified, and quantified data.

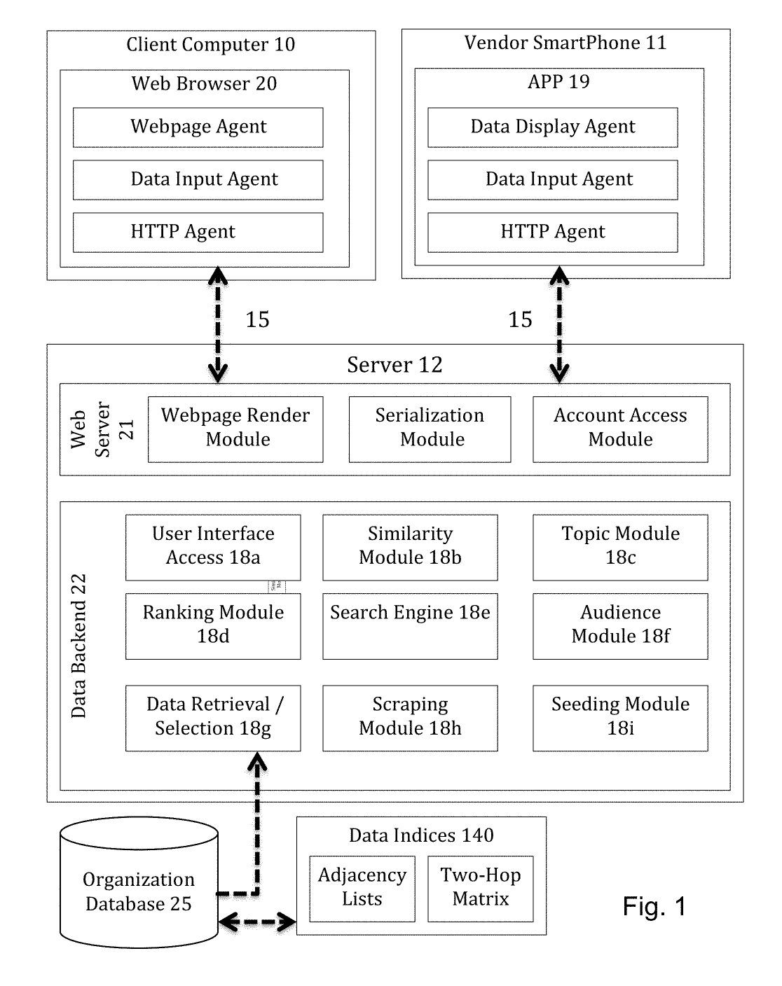

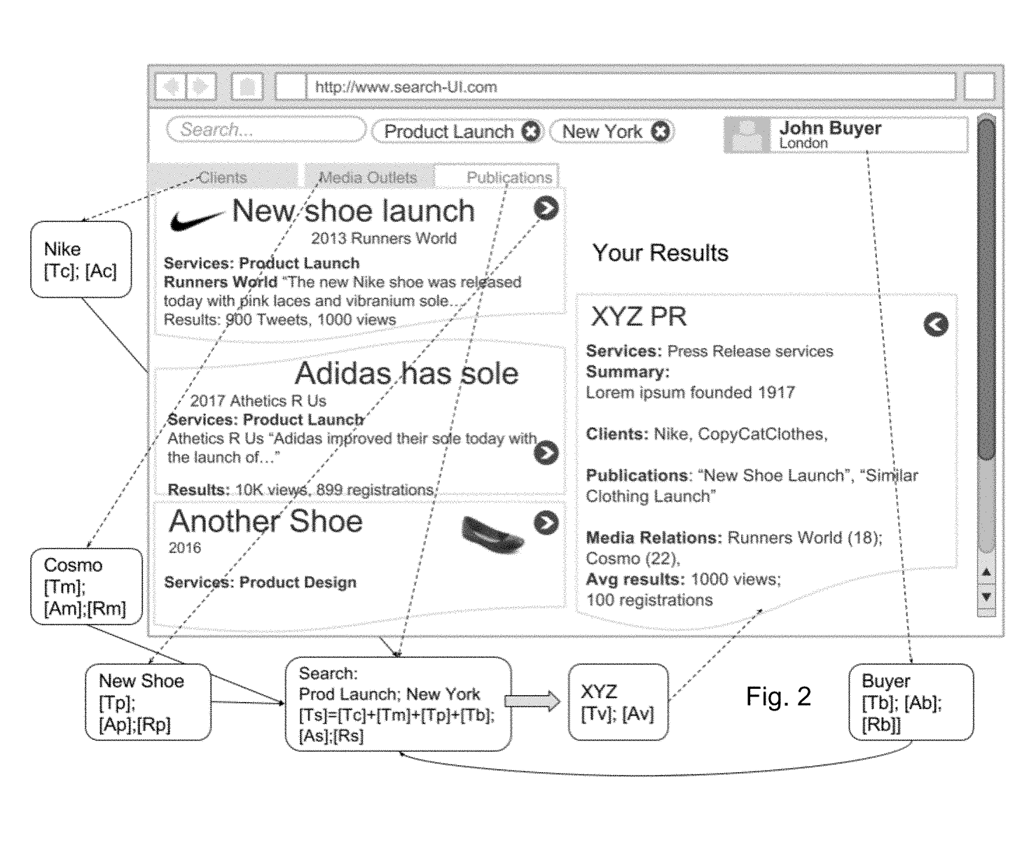

The technology is implemented using computer systems and computer processing methods. FIG. 1 is an illustration of software modules and FIG. 11 is a block diagram of computing components provided in a system enabling searching and data processing.

FIG. 1 illustrates the interaction between user device 10 and the server 11 over network link 15. The devices 10 may communicate via a web browser 19 or smartphone APP, using software modules to receive input from the user, make HTTP requests and display data. The server 11 may be a reverse proxy server for an internal network, such that the client device 10 communicates with an Nginx web server 12, which relays the client's request to backend processes 13, associated server(s) and database(s) 14, 16 and 17. Within the server, software modules 18a-l perform functions such as, retrieve data, build and process data via service model(s), match requests and Providers and calculate various score. Some software modules may operate within a notional web server 12 to manage user accounts and access, serialize data for output, render webpages, and handle HTTP requests from the device 10.

One or more processors may read instructions from computer-readable memory 29 and execute the instructions 28 to run the methods and modules described below. Examples of computer readable media are non-transitory and include disc-based media such as CD-ROMs and DVDs, magnetic media such as hard drives, semiconductor based media such as flash media, random access memory, and read only memory.

Users may access the databases remotely using a desktop or laptop computer, smartphone, tablet, or other client-computing device 10 connectable to the server 11 by mobile internet, fixed wireless internet, WiFi, wide area network, broadband, telephone connection, cable modem, fiber optic network or other known and future communication technology using conventional Internet protocols.

The web server's Serialization Module converts the raw data into a format requested by the browser. Some or all of the methods for operating the database may reside on the server device. The devices 10 may have software loaded for running within the client operating system, which software is programmed to implement some of the methods. The software may be downloaded from a server associated with the operator of the present database or from a third party server. Thus the implementation of the client device interface may take many forms known to those in the art. Alternatively the client device simply needs a web browser and the web server 19 may use the output data to create a formatted web page for display on the client device. The devices and server may communicate via HTTP requests.

The methods and database discussed herein may be provided on a variety of computer system and are not inherently related to a particular computer apparatus, particular programming language, or particular database structure. The system is capable of storing data remotely from a user, processing data and providing access to a user across a network. The server may be implemented on a stand-alone computer, mainframe, distributed-network or cloud network. Although example structures queries are shown in a particular format herein, it will be appreciated that other formats may be used using other query languages, such as GraphQL, OpenCypher, Gremlin, or SPARQL.

### Database

In the database, first data object type, representing organizations are connected to second data object types, each representing a document and optionally comprising that document. The first data objects have attribute data indicating firmographic and other data. The second data object types may also be connected to third data object types, representing media outlets/publishers. Other connections and data objects may exist to provide an improved ranking of first objects with respect to the search. These connections and objects may be modelled as a graph. The database of the present system is a representation of the graph, using structures such as tables, indices, and adjacency matrices.

For example, this system is effective for evaluating professional services such as Press Release, Product Launch, Advertisement, Video broadcasting, Image/design creation or Consumer Communications. These services share characteristics of: a) having a digital form; b) being traceable through digital sources; and c) the value of the service being in the distribution. Thus some modules of the systems are programmed to detect the digital footprint of a past service (social post, video, document, image, or reference thereto), quantify and qualify the distribution and audience, and calculate a return of that past service. Even where the output of a service is physical not digital (e.g. architecture services, package design, legal services), they may be represented indirectly by a digital form (e.g. picture of a building/package or description of a lawsuit), which is then published and distributed electronically.

As an example, the database structure may be a graph G of data objects {V, E} (vertices, edges) that are arranged to store data of and representing Organizations {O} and Documents {D}. The organizations may be companies, partnerships, charities, institutions, media companies, and government bodies. The organizations may be connected together in the database, similar to a social-network in that numerous users can assert or discover these connections. Depending on the types and directions of edges, an organization may be viewed in different roles, such as a client C, a Service Provider S, or a Media Outlet M. A Service Provider provides business services to a client. A media outlet may be a news website, social media/networking platform, or TV/radio broadcaster that stores documents about certain organizations. The document objects may comprise text, images, and metadata about the document. Documents (D) may be any digital media type (such as a news article, video, radio broadcast, TV program) that has been delivered to an online platform for consumption by viewers.

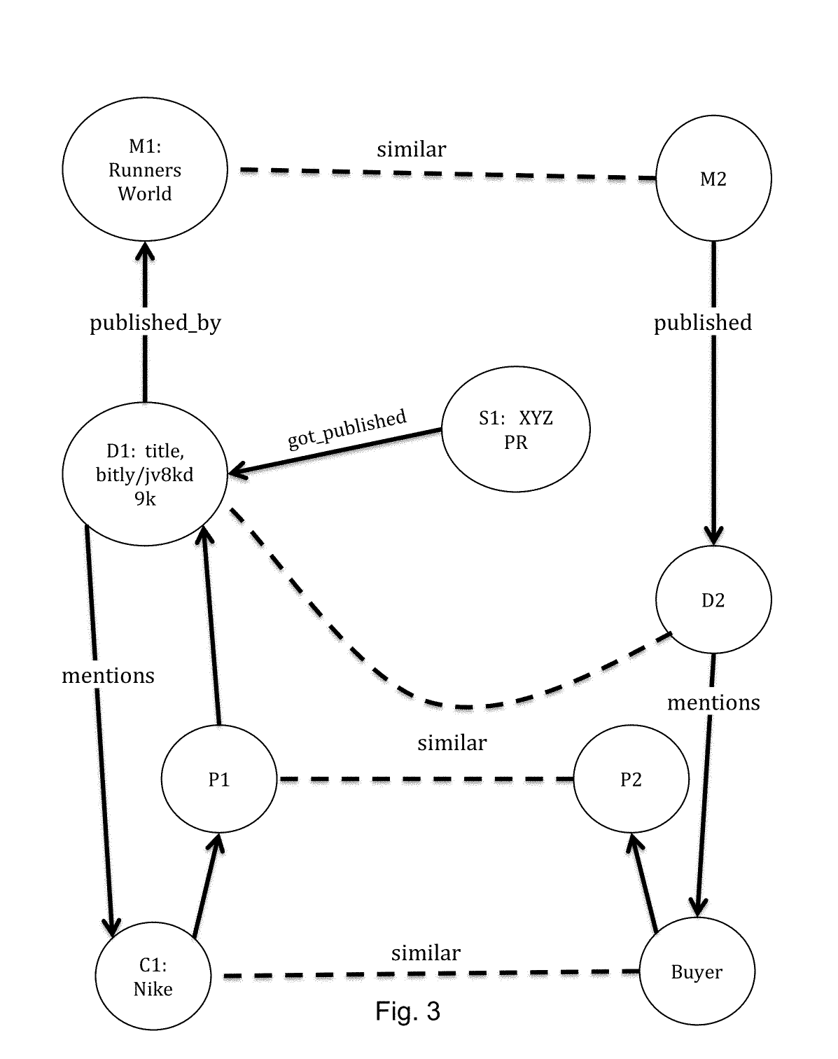

In formal terms,
G=(V, E);
V={O, D} representing the Organizations (of subtype S, M or C) and Documents;
E={(start_node, end_node, edge_type) which may represent ‘Mentions’, ‘Published’, ‘Business Relationship’, ‘Provider_to’, ‘Client_of’, or ‘Similar’ (see FIG. 3);
The graph holds J documents, K media outlets, I Service Providers, and U clients.

The graph may be stored as triples [Vertex, Edge, Vertex], using directed edges representing, for example, that document j was published by media outlet k [Dⱼ, published_by, Mₖ], that document j was due to services performed by a Service Provider i [Sᵢ, got_published, Dⱼ], that document j discusses client u [Dⱼ, mentions, Cᵤ], that two objects are similar [O₁, similar_to, O₂], or that there is a service relationship [O₁, client_of, O₂]. There may be inverse edges to represent the reciprocal connection. This exemplary graph provides a structure for the system to find and rank Service Providers (or Media Outlets) based on connections to and relevance of documents with respect to a search query.

In the example subgraph of FIG. 3, nodes are shown representing an example role as Service Provider, client, documents, media outlets, and their connecting edges are shown. Some information is omitted here for simplicity. In this example:
A Buyer is connected to a new Project P2, which project may be a text document describing the organization, their product, and goals of their project. The project may be appended to the Buyer search query to create an enhanced search query used by the search engine.
Buyer was mentioned in past document D2;
D2 was published by Media Outlet M2;
A similar connected sub graph on the left side comprises a client (C1:Nike), their project (P1), which was published in document (D1 with link bit/ly/jv8kd9k) in Media (M1: Runners World), arranged by a Service Provider (S1:XYZ PR).

There may be no explicit connections between the left-side and right-side subgraphs of FIG. 3, however, inferences are made thru similarity computations:
M1 is connected to M2, as having similar audience or topics;
P1 is connected to P2, having similar topics and tags;
Client (Nike) is connected to Buyer, having similar firmographics; and
D1 is connected to D2, as having similar audience or topics.

The similarity functions may compare the two object's meta tags, text features, firmographic attributes, or audience/topic vectors. The similarity function may calculate a scalar similarity value, which is compared to a threshold to record only highly similar connections in the database. Those similarity connections may be a weighted edge between those objects comprising the similarity value.

Thus in this example, the search engine can use the combination of recorded connections and computed similarities to calculate a path between the Buyer and Service Providers or Media Outlets, through data objects that are evidence of capability to provide the queried service. The documents provide a source of text for computing topics comparable to the search topic.

Direct connections from Service Providers to Media Outlets or to Clients (and vice versa) may be recorded, without the need for storing the intermediate documents, the connection object optionally recording a weight corresponding to the number of intermediate documents. This may be done by defining a two-hop matrix, TwoHop (O₁, O₂), which records the number of paths of length two between organizations. This can be used to quickly determine the paths between third objects (e.g. Media Outlets or clients) and first data objects (e.g. Service Providers). This provides an efficient mechanism to determine a relevance score for recommending first data objects, using objects connected thereto. The two-hop path comprises one intermediary object, such as a documents or an organization. Each element in the matrix is a relationship strength value, being the number of paths, preferably weighted by the intermediary object type and edge types. Storing these inferred connections in the matrix reduces the computing resources to determine connections for the search query in real-time.

In FIG. 3, the buyer node is shown with respect to other nodes but in fact this node might not exist in the database initially. Therefor a buyer that is not logged in, or otherwise associable with an existing organization, may be temporarily represented as a set of attributes input to the search UI, from which similar organizations are identified by the Search Engine.

### Indices

The present search engine determines whether a connection exists in the database between two nodes, where one node is explicitly or implicitly specified in the search and the other is the node to be returned. In a graph of N nodes, the search complexity is 2̂n (or N Log N for many social networks) if only one hop connections are needed. In the present graph N is on the order of millions making this a resource-consuming search. Thus the database preferably comprises additional indexes corresponding to the intended search path.

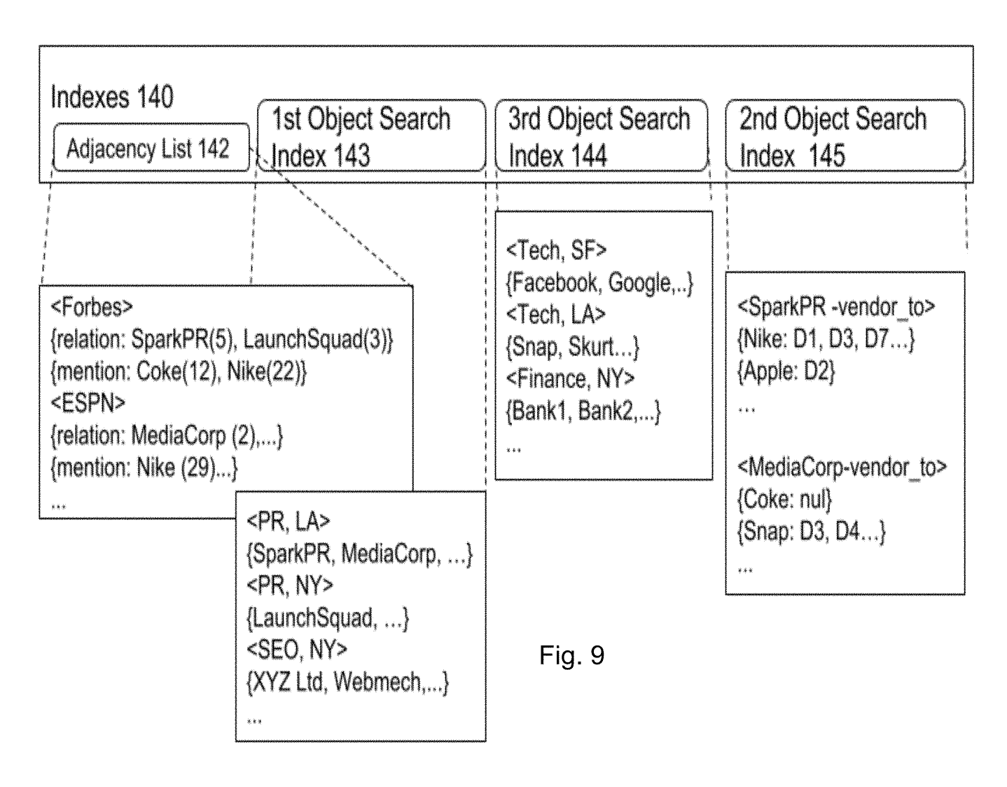

FIG. 9 illustrates four example indexes. Additional indexes are contemplated such as inverses of these indexes, where the search query specifies alternative starting nodes. For example, the search query may specify a subset of media outlets {M′} as starting nodes from which Adjacency List 142 efficiently returns all Service Providers connected to each such media outlet M′ₖ, which are compiled to create a subset {S′}. Conversely, the search query features may limit the viable Service Providers to a subset {S′} within all of {S}. Thus here the starting nodes are Service Providers from which media outlets {M′} are returned from a Service Provider Adjacency List 142′ (the inverse of 142). This may be repeated to find other objects connected to the subset {S′} or {M′}, in what is called a Breadth First Search (BFS).

Adjacency List 142 returns organizations (as clients and Service Providers), arranged by connection type (‘mention’, ‘relation’) to a given media outlet. The List 142 also returns the count of documents for that organization within that media outlet. This may be the TwoHop matrix. The search complexity is thus highly reduced to the nodes k′ in the subset {M′}, rather than k. This is especially advantageous where there are no direct connections recorded between first data objects (e.g. service providers) and third data objects (e.g. media outlets) in the graph.

Index 143 aids the search engine in identifying a subset of first data objects (e.g {S′}) that satisfy certain common search features, <feature1, feature2>. The index input is a pair of common search criteria, for common criteria values, e.g. <service, location>. Similarly index 144 returns a subset of third data object (e.g. {C′}) that have certain attributes and graph connections common in search. For example, the member of this index may necessarily be connected to first data objects by ‘client_of’ edges, and be arranged by pairs of commonly sought attributes, e.g. <industry, location>. The indexes return coarse subsets to be further reduced and scored with respect to additional search features. For example, the subset {C′} may comprise organizations with the same industry and location attributes as the buyer attributes (which forms part of the search query). The complete attributes of each member of {C′} are compared to the complete attributes of the buyer to calculate a similarity score and auto select a reduced, ordered subset of the most similar organizations {C″ₛᵢₘᵢₗₐᵣ}. Similarly, the set {C′} are displayed to the user, from which a user-selected subset {C″ᵤₛₑᵣ} is derived.

Index 145 aides the search engine to identify, given a Service Provider key, all clients of that Service Provider and the subset of documents {D′} arranged by that Service Provider for each client. The null set of documents shown for Coke™ still identifies the existence of the Service Provider-client relationship.

### Data Collection

The data may be scraped from digital sources using a scraping module. Such a module is programmed to extract data from websites, social networks and media databases, identifying blocks of text, metadata, usage statistics, and connected organizations and social media outlinks. Rather than consider all documents and media outlets, the Scraping Module preferably limits scraping to those where a connection can be identified to a Service Provider. That is, the intention is to aggregate the scores of document and media outlets towards the connected Service Providers, rather than simply score documents. For example, the scraper may target a social media source, such as Twitter, Facebook, or LinkedIn. Starting from an account of a Service Provider, the scraper identifies social posts connected to that account and parses the posts to identify links to documents and names of organizations. This approach increases the likelihood that a shared link to a document is with respect to a Service provided by that Service Provider on behalf of a client who is likely also addressed.

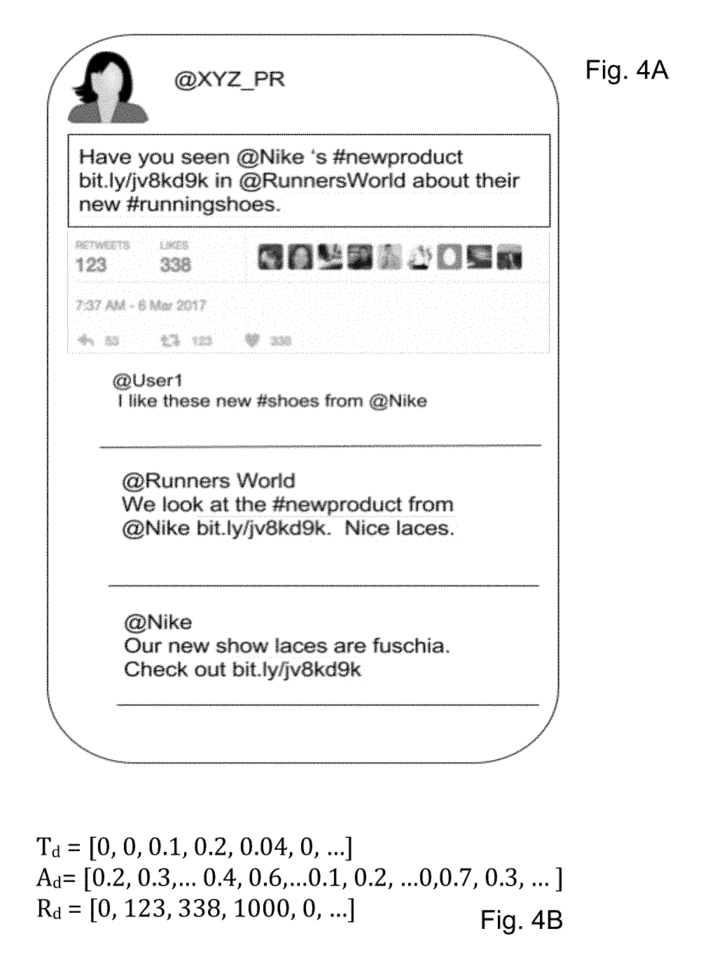

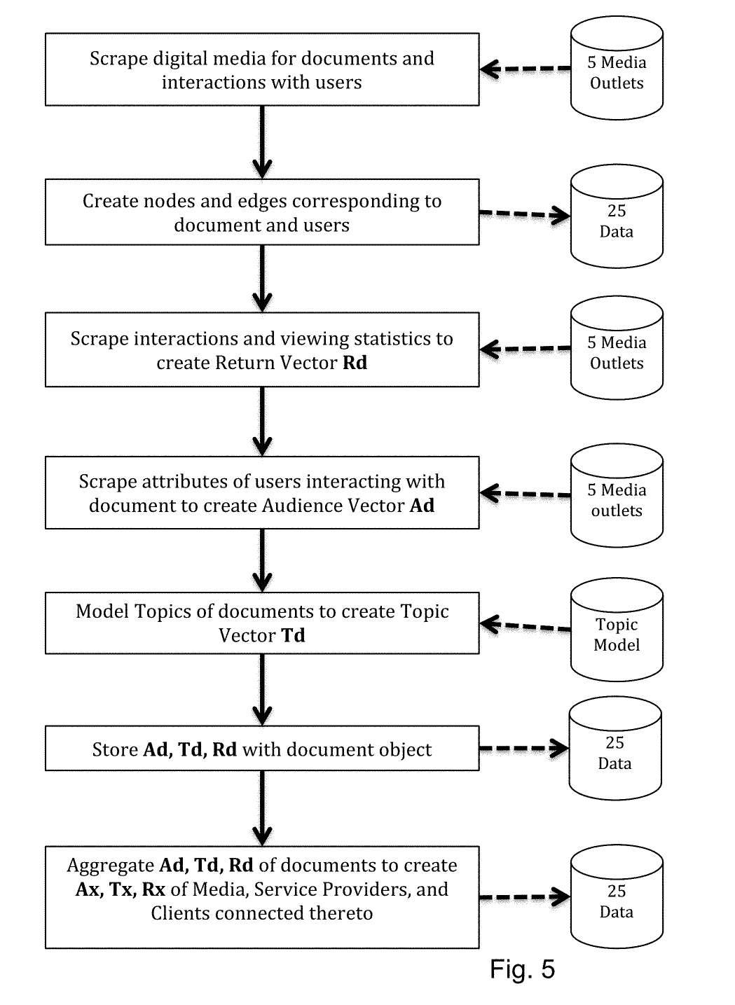

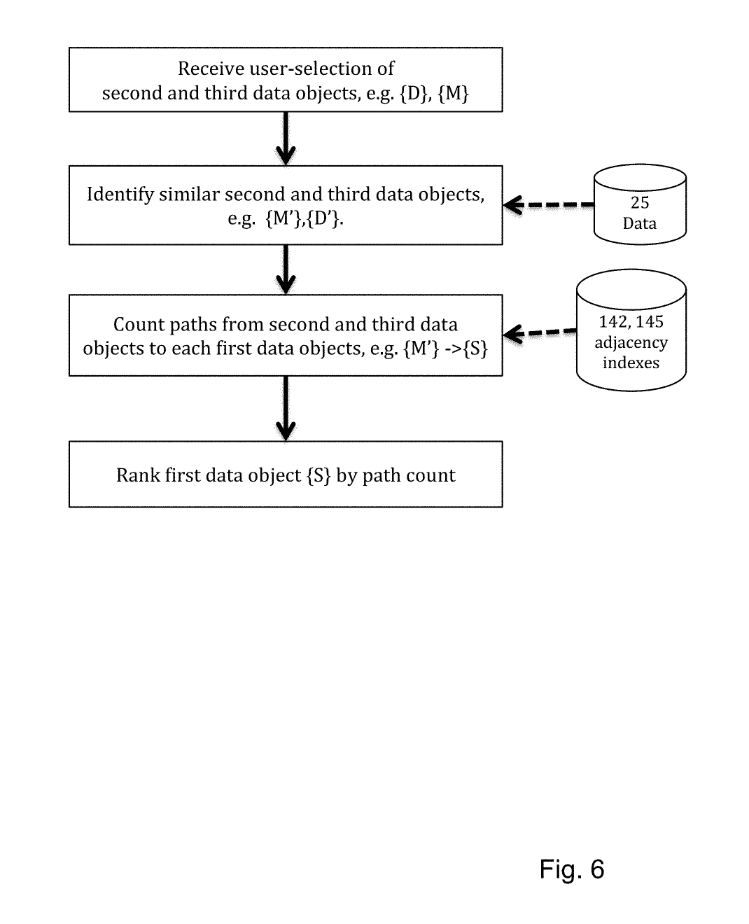

The Scraping Module follows the shared link to the document to deterministically or probabilistically extracts its text body, title, metadata, tags, name of publisher, date of document, number of shares on social media such as Twitter, Facebook, provided service and identifies named entities (e.g. place names, services, organization names, organization websites), may be related ads (to identify the audience). In the example social post of FIG. 4A, the account of XYZ PR posts a link bit.ly/jv8kd9k to a document, mentions the accounts of @Nike and @RunnersWorld and includes hashtags #runningshoes #newproduct.

The Scraping Module may also scrape the account of an organization that is a Media Outlet to determine the followers/subscribers and then extract the demographic attributes of those follower/subscriber accounts.

FIG. 11 illustrates exemplary arrangements between multiple data servers, some of which may be operated by third parties. Media Outlet servers store documents, which are retrievable by the present Search Server and Social Media Servers. The account attributes, document sharing, and social connections of social media users are observed by the Search Server

The graph is a representation of the human-created data in a format that can be understood by a search engine and processed with thousands (or millions) of further connections.

Demographic data may also be provided by third party data aggregators that collect demographic data about viewers of certain media outlets. For example, Ad Tech companies provide estimates of absolute numbers of viewers of an online news websites and the relative composition of their demographic attributes.

Alternatively, the data may be provided by users of the system. The user inputs some or all of the data such as the document published, names of media outlet/client/Service Provider, which is processed to create the graph. In this case, the input is structured to avoid misclassification or misunderstanding when put in the database, but the data is not verified by third parties. The Scraping Module may therefore follow the given the links to extract data and compare this with the asserted user data to verify the relationships probabilistically.

### Search Engine

The system may convert the user's search query into a semantic query, which enables queries and analytics of associative and contextual nature. Executing a semantic query is conducted by walking the graph's nodes/edges and finding matches (also called Data Graph Traversal).

The search engine is arranged to receive search features from the user and create a search query Q in order to find first data objects satisfying a first part of the query (Q1) and connected to second data objects that are relevant to a second part of the query (Q2). The first part of the query may specify attributes of the first data objects sought. The search engine calculates a relevancy score for each second data object's vector of features with respect to a corresponding vector of the second part of the query. The search engine then returns first data objects as search results based on the aggregate scores of second data objects connected to respective first data objects.

The search engine may infer features to form the second part of the query from features of third data objects connected to the user or relevant to the first part of the query. The search engine may output some of these third data objects to the user for selection and thereby confirming features of the second part of the query. Thus the search query process may comprise two or more steps to define parts of the query.

Returning to the prior example, the first part of the query may comprise search features specifying desired attributes of Service Providers to return as search results. An evaluation of the value of past services by a Service Provider may be calculated by the distribution and relevance of the audience that interact with the tangible outcome of the services, such as a published document. Thus the system records and processes the audience of each document and/or media outlet in terms of quality, geographic reach, audience size, audience demographics/firmographics. For the most granular evaluation, the system computes audience statistics for each document and then aggregates the audience statistics for a plurality of documents to compute an overall score for a connected media outlet or Service Provider organization. The system may use an audience vector to store audience statistics, the vector comprising a probability mass over features, such as age ranges, industries, locations, and job titles.

The user-attributes (e.g. firmographic/demographics) of users that view/post a document are mappable to an audience vector and the aggregate of all user-attributes creates a weighted audience vector for the document. Similarly, a set of these document audience vectors creates a media outlet audience vector. These audience vectors are stored in the datastore in association with the respective document object or media object.

Thus rather than estimate the audience of a particular document from the publisher's normal audience statistics, the audience is built up more precisely from its individual users. Similarly, media outlet or Service Provider audiences are built up from audiences of documents connected thereto.

The search engine receives search features via a user-interface from a client-computer operated by a Buyer-user on behalf of a Buyer-organization. The UI is provided by the search server as a text box, voice input, filter options, or sequence of questions and selections. Pre-processing may be needed to convert free-text or voice to a structured query operable on the present database. See U.S. Ser. No. 15/730,628 filed 11 Oct. 2017 for details on converting unstructured query to a structured query, whereby the nodes and connections to be identified correspond to those discussed herein.

The query may include one or more of the following search features:
Media Outlet name;
Client name;
Reference to a particular document by link, title or citation;
Desired audience demographics/firmographics;
Topics relevant to the buyer's project;
Service requested from the Service Provider;
Desired results of the service; and
Connection between one specified object and another, e.g. a free-text query for “documents mentioning Client X” or “documents published by Media Outlet Y.”

The search engine may perform two or more steps to define the search features. Various input sequences are contemplated to specify all parts of the search query, such as:
1) Specify buyer attributes-select client organizations-select documents-select Media Outlets-Show Service Providers
2) Select documents-select media-select companies-Show Service Providers.
3) Select Media Outlets-select documents-Select Audience vector-Show Service Providers.

Thus after each step in the query sequence, the search engine provides intermediary search results from which the user selects one or more objects to further specify search features. The intermediary search results may be second data object types (e.g. documents) third data object types (e.g. media outlets, client organizations), topic features, audience features, and result features selected by the search engine from their relevance to search features already defined. Thus in Sequence 1 above, the selectable documents are those connected to the user-selected client organizations. This method reduces the number of selectable objects that need to be shown to the user and simplifies the search process.

The present database may comprise millions of documents and organizations. This means that displaying them all is impractical but it is also unlikely that a user would know a priori which data objects are connected in the database to the first objects being sought. In preferred embodiments, the search engine considers data objects that are similar to those objects selected by the user, rather than just the selected objects, to create an expanded set of user-selected objects, e.g. {D′″} or {M′″}. Thus the set of objects may be both reduced by user-selection and expanded using a similarity module.

The search engine may identify data objects connected to the Buyer object in the database and add these objects or their attributes to the user-specified search features. Returning to the example of FIG. 3, the Buyer's connected components comprise the Buyer-organization object, past document D2, present project document P1, and Media Outlet M2. The search query may be extended even further by including data objects that are calculated to be similar to buyer-connected objects (buyer subgraph) and user-specified objects. In the example shown, the Client C1, document D1, Media M1, and project P1 are identified from the pre-computed similarity connections to the Buyer's connected objects.

The system preferably computes a similarity score for objects that are similar to the user-specified objects and buyer subgraph in order to weight the contribution of these objects in calculations described below.

### Vectors

In the real-world, a document may be a published article comprising text and images created and hosted by a media outlet for discussing organizations and people. In the digital world, a document is a digital object comprising text strings, image files, hyperlinks and metatags. In the present system, the document is accessible and sharable by users using a link to a document object in a media server. Thus the digital representation of the document also provides a data source for tracing the distribution of it through a network of users. The original document may be stored on the data server of the Media Outlet and the original social sharing through social media websites. The present system need only store representations of documents as a distribution over topic clusters or topic tags, reducing computer resources otherwise needed to store the whole document and reducing processing time otherwise needed to search and convert each document, for every search. The database may comprise topic matrices Td, Tm, Tc and Ts, for objects of type: document, media outlet, client, and service provider, respectively. Alternatively there may be a single matrix T for all vertices. If there are t topics then Td is a [j×t] matrix, Tm is a [k×t] matrix, Ts is a [i×t] matrix, and Tc is a [u×t] matrix

Similarly the demographic values of users that interact with each object may be represented and stored as matrices, hereafter called Audience matrix A (or separate matrices Ad, Am, Ac and As). Similarly the effect of a previous service may be collected offline and computer as a Return scalar, Return vector or Return matrices, denoted R.

Exemplary computations of T, A, and R are explained further below. While for convenience of understanding, the topics, audience and return of a document are discussed as separate dimensions used by the system, the skilled person will appreciate that these dimensions may be represented in alternative but mathematically equivalent ways. For example, elements of two vectors may be combined into one longer vector or a single vector could comprise elements that are the multiplication of two vectors.

### Rank

As discussed above, the search engine scores second data objects based on relevance to the search query, which scores are then aggregated towards first data objects connected to second data objects. This relevance score may be part of the total scoring of first data objects, from which the search engine determines the ranking of objects. The objects are communicated to the user according to the ranking, from highest ranking to lowest.

The relevance score for a each of the second data objects is computed by comparing their audience, topic and relevance vectors to the corresponding vectors of the search query. This calculation may comprise vector distance (such as Cosine Similarity, Jaccard Distance, Manhattan Distance), F-divergence of probability mass distributions (such as Kullback-Leibler-divergence, Hellinger Distance, Total Variation Distance). It is preferable that the calculation returns a scalar value that increases between more similar vectors (i.e. a measure of proximity instead of distance).

In the current example, the relevance score of a document, media outlet or organization depends on the proximity of each such object's audience, topic, and result vector to the corresponding vectors of the search query Aq, Tq, and Rq. For example, the search engine may calculate the relevance score for document j based on its audience, topic and result vector (Aⱼ, Tⱼ, and Rⱼ) from the matrices weighted by the importance of documents Wd:

Rel_Audienceⱼ=Wd*Adⱼ*Aq; Eq 1

Rel_Topicⱼ=Wd*Tdⱼ*Tq; Eq 2

Rel_Resultsⱼ=Wd*Rd_{,j}*Rq; Eq 3

Each of these relevance scores can be combined as a linear sum or sum of squares. For example,

Rel_totalⱼ=Rel_Resultsⱼ\sqrt{Rel_Audienceⱼ²+∝Rel_Topicⱼ²} Eq 4

combines the semi-orthogonal dimensions of audience and topic and the overall magnitude of the result. Here ∝ represents the relative weight of topic similarity to audience similarity.

The score of each first data object (e.g. Service Provider) is the weighted combination of relevance scores of second data objects (e.g. document) and third data objects (e.g clients, media outlets) connected to that first data object. This total may increase linearly, sub-linearly (e.g. log), with diminishing results (e.g. using s-functions), or up to a predetermined maximum.

### Selecting a Set of Documents

The system provides an improvement to defining the audience of a particular media outlet. Conventionally, readers of a media outlet are surveyed and compiled to define the audience in terms of demographics. For example, Forbes' main audience may be described as 56 Million readers, American, business people, and aged 40-55. More granularly there may be a known distribution over all reader ages, genders nationalities, etc. However this model is noisy and over-simplifies the audience and topics, given the numerous section of the media outlet and their numerous documents. Such a model assumes these readers are evenly distributed over each document. In reality a given article about a certain topic attracts a subset of readers different from the larger population of readers. The present system provides a method for representing data objects from a subset of their connections, for example to provide a personalized perspective of clients, Service Providers or media outlets with respect to the search query and the buyer node.

For example, a given client Cᵤ may be better defined by a subset of their connected documents {D′|Cᵤ} to create a new audience vector Ac_{u|d′} and a new topic vector Tc_{u|d′}, which are different from (and more precise than) those vectors created by all connected documents. Ac_{u|d′} is the new audience vector of Cᵤ derived from {D′}. The search engine may select the subset of data objects (e.g. documents) based on their attribute(s) that satisfy part of the search.

Moreover the same client may be discussed by a second media outlet in a second set of documents, which set is defined differently again by a second audience vector and a second topic vector.

### Audience

It is computationally efficient to preprocess the demographic and firmographic data of users that interact with or distribute a given document and store this data as an audience matrix. Additionally audience matrices for Client Ac, Service Provider As, and Media Outlet Am objects may be precomputed from the combination of audience vectors of document objects connected thereto. The raw audience data may be imperfect or unknown for certain objects, such that estimates and surrogate data are identified and used to estimate audience vectors in some cases.

The Scraping Module observes user-interactions with documents on digital platforms, such as LinkedIn, Facebook, Reddit, Twitter, Disqus, Yahoo groups, or the media outlet itself. For each user-interaction event, an Audience Module determines or estimates demographic/firmographic attributes such as age, gender, industry, location, education, and job class. These attributes are preferably determined from the user-profile of the user interacting with the document but may also be determined from attributes of the forum within the digital platform where the interaction takes place. For example, a document may be viewed/shared within a forum/group/media outlet section which include titles, description or metadata to indicate that the intended members have certain common attributes (e.g. executive marketing personnel in high tech industry).

The attributes determinable will depend on what is available and the type of platform. For example, some platforms may record user job title but not age. It is not essential that every user attribute or every user interaction is captured, as the audience vector is an approximation of the population of users that interact with a document.

FIG. 4A demonstrates social sharing on a digital platform of a link to a document (bit.ly/jv8kd9k) amongst social accounts belonging to people and organizations that are Service Providers, clients, and media outlets. The Scraping Module observes these user-interactions and may record connections in the present database between the document and the people/organizations that correspond to the accounts of the people/organization on the platform. The Scraping or Audience Module follows the links to each of the accounts of those interacting with the document and retrieves their demographic/firmographic attributes.

The Audience Module may count the number of users for each demographic/firmographic attribute. More preferably the count is a weighted count, where the weight depends on the type of interaction a user has with a document. For example, the Audience Module may increase the count for demographic attribute of those users that share a document more than for demographic attributes of those users that merely view a document. The weightings may be stored in a table for each type of interaction (e.g. sharing, re-sharing, commenting, viewing, Liking, etc).

The final audience vector is preferably normalized to capture probability mass distributions rather than absolute measure of user interactions. FIG. 4B provides an example of an audience vector of a document [Ap], where the elements correspond to [age 20-39, age 40-59, . . . Male, Female, mining industry, legal industry, . . . executive, mid-level, junior, . . . ].

### Topics

As a digital source of keywords, n-grams, named entities, metatags, a document is a valuable source of data for comparison with a well specified search. In particular, those search features may be explicitly described in a document, such as a project description. However, documents may be several hundred words long and is not structured for computationally efficient manipulation and comparison by computer means.

Thus a Topic Module uses Natural Language Understanding to preprocess each document by identifying the body of the text (from the surrounding HTML code) parsing the text into n-grams, correcting spelling errors, stemming and lemmatizing, removing stop words, identifying named-entities (e.g. locations, real names, search filter terms), and calculating TF_IDF weights to create a set of features {FD} for each document. The set of features of each document may be stored as a feature vector, comprising a count of the number of occurrences of each feature in the document along a pre-ordered set of features.

The Topic Module may process the set of features using a topic model to create a topic vector t, which is a statistical distribution (e.g. probability mass distribution) of topics of the document over all topics that make up the topic space in the topic model. The topic model itself is created by a clustering algorithm using a large corpus of documents to determine clusters (i.e. topics) that span the documents. Each topic may be defined by a set of n-grams or distribution over n-grams. Topic Modelling is discussed in detail in U.S. Ser. No. 14/877,774 filed 7 Oct. 2015.

In unsupervised clustering, certain clusters will be created that do not correspond to useful topics, such as topics that are likely to be part of the search query. To reduce the topic feature dimensionality and focus on topics comparable with the search, a semi-supervised technique may be used to limit the topics to a set of predetermined n-grams that are related to features used by the search query.

More preferably, the Topic Module using a supervised Machine Learning technique to classify a document from its extracted features or topic clusters. The classifications of the document are the machine representation of that document's topic, which are then comparable to other documents or the search topic. To provide granularity, each document may be assigned a plurality of topic tags. To ensure that the topic tags are relevant to the system's purpose and the nature of the searches expected, it is preferable that supervised learning is used to build the tag classifiers.

Thus a subset of representative documents may be manually tagged, each with a plurality of tags. The Topic Module preprocesses the text to extract features, self-learns topics clusters from the features, and learns a mapping from topic clusters to the known topic tags. Subsequently the Topic Module pre-processed new documents to extract features, estimates the distribution over topics clusters from the features, and outputs a set of topic tags from the topic cluster distribution.

The system may be optimized to search for organizations connected with documents within a particular field by training the Topic Module classifier using a large set of documents within that field that have been manually tagged with topic tags that are relevant to the document and the search. For example, a system optimized for finding companies involved with the technology may source articles from science and technology magazines and blogs. The relevant topic tags might be {smart phones, VR hardware, firmware, computer chips, Internet, ecommerce, camera, . . . }. Such a system would not be tuned to find or discriminate between finance, lifestyle or political articles.

The feature vector or topic tag vector of each document is precomputed and stored in a Topic matrix. Thereafter the Search Engine may calculate a topic score of a document Td with respect to the search query Tq using, for example, Kullback-Leibler divergence. This is computationally efficient compared to comparing an unprocessed document to a search query terms.

FIG. 4B provides an example of an audience vector Td of a document, where the elements correspond to distribution over [mining, technology, clothing, product launch, fashion, forestry, . . . ].

### Results

In preferred embodiments, the system records and processes data such as the distribution and effect of digital representation of a provided service to estimate how successful its results were. The results of a document may be stored as a vector r_{d} of multiple observations about results, such as posting, social sharing, ‘tweets’/‘retweets’, views, virality, or ‘Likes’. The results of all documents are stored in a matrix Rd. Similarly, the search may indicate desired results Rq as a corresponding vector, where the vector values define the goals of the searched services. Such values may be explicitly set by the Buyer-user but in preferred embodiments are set automatically by the system to reduce user time and system complexity.

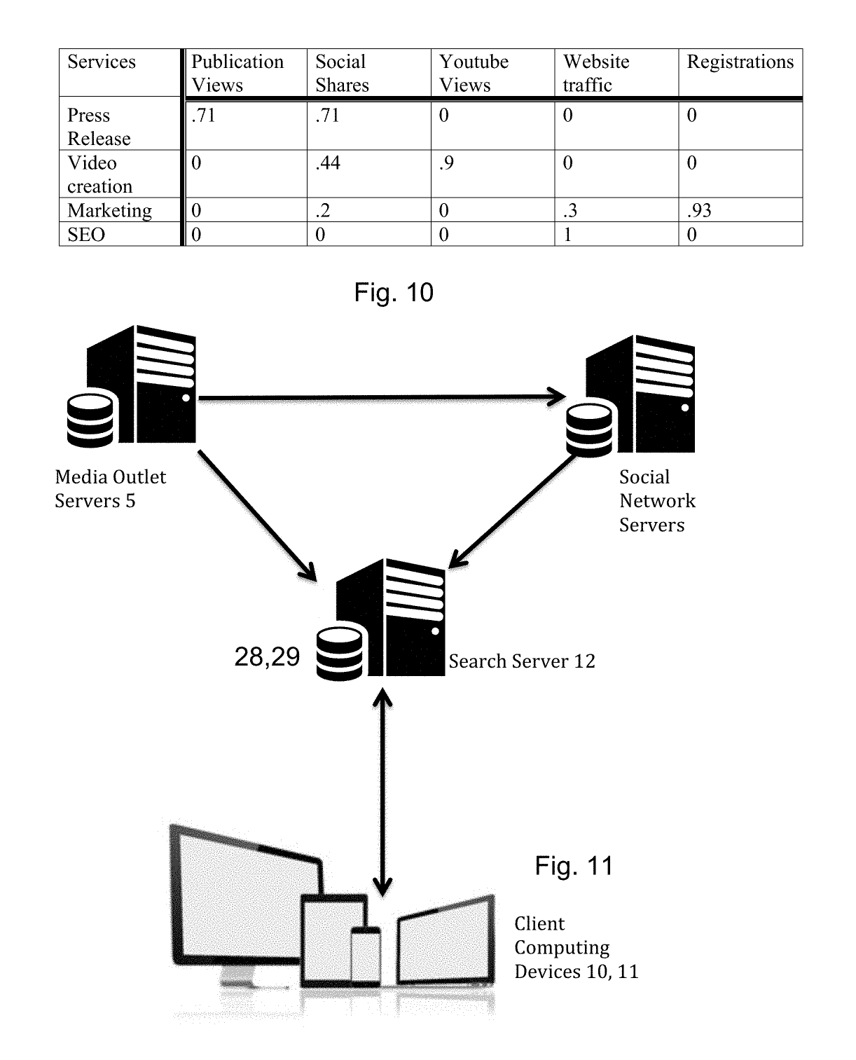

The system may employ a data structure such as a table of services, each service having a corresponding Rq vector to weight the success metrics to that service. The length of each vector Rq is preferably a constant. Vectors may be added (e.g. for multiple search services) and the length then normalized to that constant. The Table in FIG. 10 provides example weights for the vector Rq. The result values may increase with the absolute success (e.g. linearly or logarithmically). Thus documents that have higher absolute views and shares will have a greater vector length, i.e. they are not normalized.

The return R may alternatively be a single value, which represents a certain success metric relevant to the service. This may be from a single data measurement or aggregate of several data measurements that are expected to best indicate success for that service. This solution simplifies the system resources but is less flexible with respect to the success a service has provided or the success that is sought be the buyer-user.

For a given object, the system may determine its score partly by the magnitude of the return. In an improved embodiment, the return vector R is multiplied by the search return vector Rq to return a scalar results relevance score that represents the magnitude of the return of the object that was relevant to the service sought. This score may be incorporated with the dimensions of audience and topics to rank Service Providers.

FIG. 4A exemplifies a social sharing of a document where the number of Tweets, Retweets, comments, and Likes are recorded. These statistics for each event are retrieved by the Scraping Module to compile values for the return Rd, exemplified in FIG. 4B where the elements correspond to [registrations, retweets, Likes, views, Quora upvotes, . . . ].

### Seeding Buyer Vectors

To complement the topic, audience and return vectors of the data objects, the system creates topic Tq, audience Aq and return Rq vectors for the search, as part of the search query. The Search Engine may determine values of these buyer vectors from a) features specified in the search query, b) the buyer's data object, c) the objects selected by the buyer-user, d) objects connected to the buyer in the database, or e) objects similar to the objects in b), c), and d).

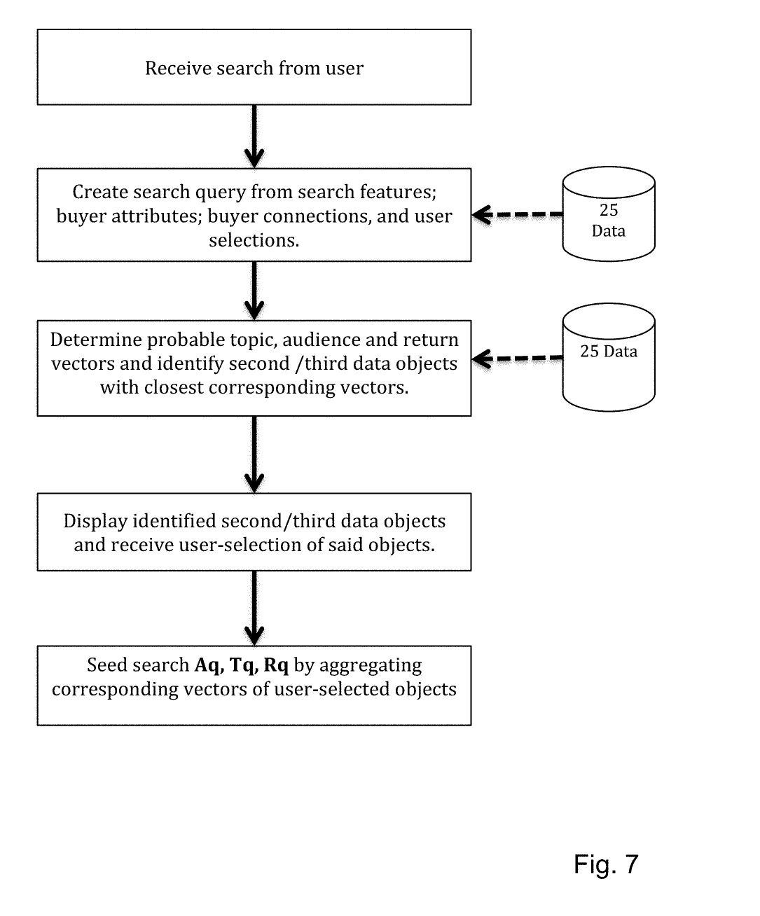

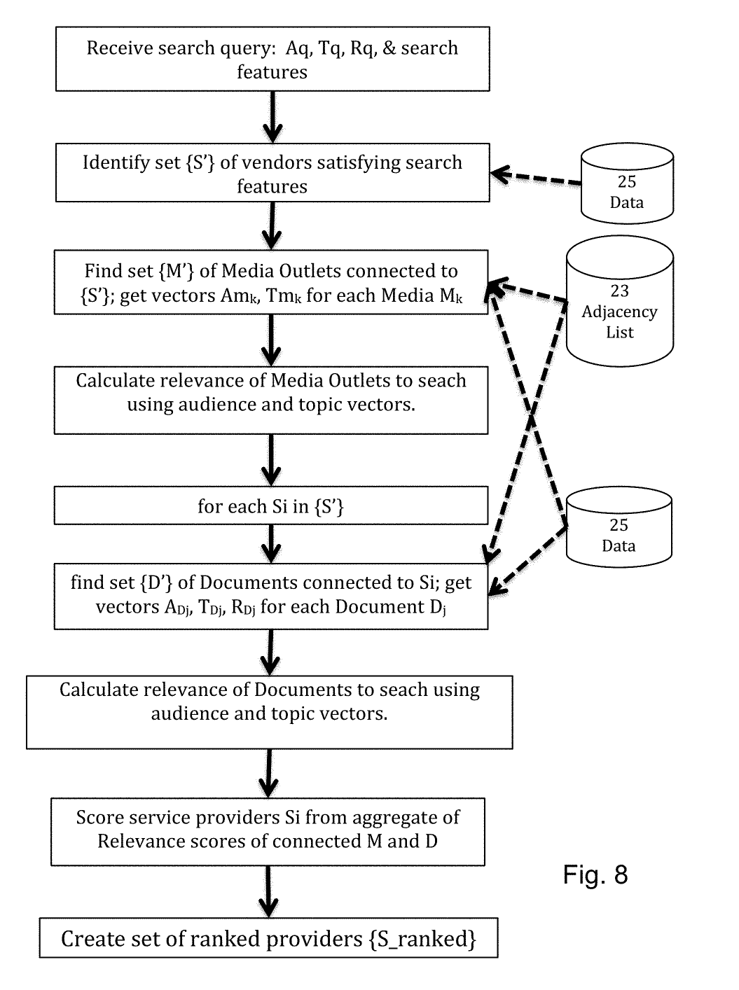

FIG. 7 illustrates input for a search query comprising search features, a search document, user-selection of data objects, and buyer attributes. The search engine locates the set of selected data objects and buyer object in the database, potentially expanding the set to include objects that are computer to be similar. The search engine retrieves the audience, topic and return vectors for at least some of these objects. A Seeding Module combines these vectors to create the corresponding buyers vectors. The combination may be a weighted sum of each vector, where the weighting is proportional to a proximity score of the object with respect to the buyer or buyer-selected objects. The vectors are preferably normalized, e.g. the cumulative mass distribution over each vector's elements is a predetermined constant.

Additionally or alternatively the Search Engine maps features in the search query to features in the search vectors. For example the search query may explicitly state the desired return features, expected topics/keywords about the buyer' future document, and desired audience attributes of that document. The search engine may use a mapping model or natural language understanding (NLU) to infer features of the buyer's vectors from the search query, including the search document and buyer attributes.

For example the system may comprise a table for mapping each service in the query to a normalized return vector, as shown in FIG. 10. The automated creation of buyer vectors reduces the time needed for the buyer-user to specify a search compatible with the underlying data structure.

### Missing Data

It is possible to implement a system in which not all the above data are recorded in the database. Certain data may be missing due to storage limits or lack of access. However, present system is robust to such absent data and may use connected data as a surrogate or infer connections from related data sources. The following are example solutions to situations where data are missing.

Either of documents objects or media outlets objects may be omitted, in which case the search engine relies on the other of document or media outlet to evaluate and find a path to Service Provider objects.

Audience data may be omitted for some or all documents (e.g. due to lack of access demographics of users on a social platform), in which case the audience data of the connected media outlet is used as a surrogate. Audience data for media outlets are generally available from the media outlets themselves or from third-party digital ad servers.

Topic data of a media outlet may be omitted (e.g. due to overly broad range of topics discussed across all their documents or low confidence in the estimated topics), in which case the topic vectors of select connected documents are used as surrogate or no topic data calculations are made for media outlets.

Return data of a document object may be omitted (e.g. due to lack of social sharing statistics), in which case the typical audience size of the connected media outlet may be used as a proxy for that document's Return.

### Block Chain Structure

In certain embodiments, the data about publications in a distributed ledger or blockchain format. The system may use various chain known platforms that can record transaction and store metadata, such as EOS, Ether, and Bitcoin. Each platform has its own language and protocols, adaptable to implementing the present system.

Past business services may be asserted by creating a transaction or Smart Contract (SC) having metadata, which is then digitally signed by the asserting organization and countersigned by an Oracle or by another organization to the service. The metadata may include a link (e.g. URL) and date of a publicly accessible document, such as a news article, social media post, or image/video sharing website. The asserting organization (e.g. the Service Provider) digitally signs the transaction or SC and broadcasts it to mining nodes to incorporate into the blockchain.

Preferably the transaction is sent to an Oracle or second organization relevant to the work, such as the media outlet or the client. That second organization verifies the metadata and digitally signs the transaction, prior to it being broadcast.

To reduce storage requirements, the document is preferably provided as a hash of the original document. Thus even if the original document is removed or no longer publicly available, a party with a copy can produce a hash that matches the hash now stored as metadata in the transaction. Similarly, the Oracle provides the transaction with a trusted verification that the document did exist at the asserted date and URL, even if the document is removed later and to save other parties from having to verify the data themselves.

As the distributed ledger is publicly viewable by many users, various search engines may use the data to identify organizations that have provided certain searchable services. Thus although the transaction or SC may store service keywords, audience and topic features, in preferred embodiments, the search engine extracts these features after the transactions are stored. Thus different engines may extract features using different techniques, weights, or trained on different aspects of the document. Each search engine may thus focus on a different subset of all transactions and may store their own indices/matrices of documents for real-time searching and in case the original documents are removed.

Similarly, organizations may provide assertions about services provided or received by referring others to blocks containing relevant transactions. A website may display a set of documents relevant to certain topics, audiences and results by providing links to the transactions. A browser or third-party plugin could verify that the document provided in the website has the same hash as a document that was recorded at a certain date and URL, and countersigned by other parties. Advantageously this also means that organizations making assertions about past services cannot alter those assertions or deny them once they are stored on the blockchain.

### Display

Every data object has a visual representation to be displayed to the user. This representation is made from an automated selection of certain data elements in the data objects, some of which may be aggregated (e.g. union, intersection, or summation). The representation may be a profile page, image, video or block of text. A representation of one data object may include representations of other associated data objects, e.g. a Service Provider's profile page may contain its attribute data as well as images of associated case study objects.

The system receives queries and communicates results to users via a user interface on the user's computing device. The system prepares web content from the first and second data objects. A serialization agent serializes the web content in a format readable by the user's web browser and communicates said web content, over a network, to a client-computing device.

Display to a user means that data elements identifying a Service Provider are retrieved from a user profile object in the database, serialized and communicated to user device 10 for consumption by the user. Display of a document may similarly be made by displaying the text from the document or a multi-media file (e.g. JPEG, MPEG, TIFF) for non-text parts of data objects.

The above description provides example methods and structures to achieve the invention and is not intended to limit the claims below. In most cases the various elements and embodiments may be combined or altered with equivalents to provide a recommendation method and system within the scope of the invention. It is contemplated that any part of any aspect or embodiment discussed in this specification can be implemented or combined with any part of any other aspect or embodiment discussed in this specification. Unless specified otherwise, the use of “OR” and “/” (the slash mark) between alternatives is to be understood in the inclusive sense, whereby either alternative and both alternatives are contemplated or claimed.

Reference in the above description to databases are not intended to be limiting to a particular structure or number of databases. The databases comprising documents, projects, business relationships or social relationships may be implemented as a single database, separate databases, or a plurality of databases distributed across a network. The databases may be referenced separated above for clarity, referring to the type of data contained therein, even though it may be part of another database. One or more of the databases and agents may be managed by a third party in which case the overall system and methods or manipulating data are intended to include these third-party databases and agents.

For the sake of convenience, the example embodiments above are described as various interconnected functional agents. This is not necessary, however, and these functional agents may equivalently be aggregated into a single logic device, program or operation. In any event, the functional agents can be implemented by themselves, or in combination with other pieces of hardware or software.

While particular embodiments have been described in the foregoing, it is to be understood that other embodiments are possible and are intended to be included herein. It will be clear to any person skilled in the art that modification of and adjustments to the foregoing embodiments, not shown, are possible.

1. A computer-implemented method for searching a database that represents a graph of first data objects connected to document objects, the method comprising:
receiving a search query from a user;
identifying a plurality of first data objects that satisfy a first part of the search query;
executing a forward query in the datastore, from each of the identified first objects to identifying document objects connected to one of the identified first objects;
identifying topics of each document object;
calculating a relevancy score for each identified document object from their identified topics in comparison to a second part of the search query;
ranking the first objects using the relevancy scores of document objects connected thereto; and
displaying a subset of the ranked first objects to the user.

2. The method of claim 1, wherein each document object is associated in the datastore with a plurality of demographic values, representing an audience of a document of the document objects and wherein the second part of the search query comprises user-desired demographic values.

3. The method of claim 1, wherein each document object has an audience vector, which audience vector is compared to the second part of the search to calculate the relevancy score.

4. The method of claim 1, wherein each document object is connected in the datastore to a plurality of demographic objects, the method further comprising traversing the datastore from each document object to connected demographic objects to assemble a set of demographic values to associate with that document object.

5. The method of claim 1, wherein the document objects and the second part of the search query comprise an audience vector and the calculation of the relevancy score comprises computing a similarity function between the respective vectors.

6. The method of claim 1, further comprising displaying at least a subset of the identified document objects as intermediate search results to the user and forming the second part of the search from topic features of user-selected second data objects.

7. The method of claim 1, further comprising identifying audience features for each document object and calculating the relevancy score for each identified document object using the identified audience features in comparison to the second part of the search query.

8. The method of claim 1, wherein identifying topics of each document object comprises looking up a set of topic features in a topic matrix.

9. The method of claim 1, wherein the database is stored on a blockchain as a plurality of transactions, each transaction comprising metadata of the document and being digitally signed by an organization represented by one of the first data objects.

10. The method of claim 9, wherein the metadata comprises one or more of: a date of the document publication, a link to a document, an identifier of a client organization, an identifier of a media outlet, and a hash of the document.

10. The method of claim 1, wherein each document object represents a service provided by an organization and stores an online address of at least one of: an image file, a news article, a video file, and a social media post.

11. A system comprising:
a datastore of objects representing organizations and documents; and
a query serving system including:
at least one processor, and memory storing:
an index of the graph-based datastore, the index including lists of organization identifiers, each organization identifier associated with at least one document identifier, the at least one document identifier identifying a document object;
a matrix storing a plurality of sets of topic features, one set for each document in the datastore, and
instructions that, when executed by the at least one processor cause the query serving system to:
receive a query that comprises at least two parts, a first query part for identifying first data objects and a second query part for calculating relevance of document object;
identify a first set of first organization identifiers that satisfy the first query part;
execute a forward query path on the index from each first organization identifier to generate a set of document identifiers connected thereto,
for each document identifier,
retrieve the corresponding set of topic features from the matrix,
calculate a relevance score based on the retrieved set of topics features compared to the second query part;
rank the first organizations based on the relevance scores of documents connected thereto; and
return search results using the ranked first organization.

12. The system of claim 11, further comprising a topic matrix storing a plurality of sets of topic features for each document, and wherein the instructions,
for each document identifier in the set of document identifiers connected to first data objects,
retrieve the corresponding set of demographic values from the audience matrix, and
calculate the relevance score partly based on the retrieved set of demographic values compared to the second query part.

13. The system of claim 11, further comprising an audience matrix storing a plurality of sets of demographic values for each document, and wherein the instructions,
for each document identifier in the set of document identifiers connected to first data objects,
retrieve the corresponding set of demographic values from the audience matrix, and
calculate the relevance score partly based on the retrieved set of demographic values compared to the second query part.
